(19) United States
(12) Patent Application Publication
(10) Pub. No.: US 2005/0204887 A1
(43) Pub. Date: Sep. 22, 2005

(54) Cutting guide

(76) Inventor: Roland Fries, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 10/801,278

(22) Filed: Mar. 16, 2004

(51) Int. Cl. B26D 5/00

(52) U.S. Cl. 83/745; 83/13

(57) ABSTRACT

A cutting guide for effecting straight accurate cuts along a workpiece includes a clamp, a saw guide pivotally coupled to the clamp and having a guiding edge for bearing support for a portion of the saw so as to guide the saw during the cutting operation of the workpiece, and a cutting template. The cutting template is cuttable so as to produce a template cutting edge on a first template portion and a second discard portion. The template cutting edge identifies the position of the guiding edge relative to a cut line for a specific saw and for a specific angled cut. The cutting template may be used to cut subsequent workpieces having the same cut configuration and using the same saw. A user may have a plurality of cutting templates, each having a different first template portion configuration.

### FIELD OF THE INVENTION

This invention relates to saws, and more particularly, to a cutting guide for effecting a straight and accurate cut along a workpiece.

### BACKGROUND OF THE INVENTION

Power saws, such as circular saws, jig saws, miter saws and other saws are used extensively for cutting wood and other types of materials. When doing so, the cutting operation should be performed as accurately and safely as possible. In many instances, the cutting operation is to be performed along one or more straight line segments on a workpiece and therefore, performing straight cuts is essential to high quality carpentry and construction.

Guides that cooperate with the saw so as to execute a straight cut along a workpiece are generally well known. The guide helps to reduce the inaccuracies or errors that would otherwise result if the saw inadvertently moved or bumped during the cutting operation. Power saws generally include a housing in which an electrical motor is mounted and the motor in turn is operatively connected to an arbor on which the saw blade is mounted. For many types of saws, the saw further includes a saw plate or shoe that provides an opening through which the saw blade projects. The saw plate also supports the saw when positioned on a workpiece. A side edge of the saw plate is generally parallel to the saw blade and at a predetermined, fixed distance from the saw blade. The side edge of the saw plate is often used as a bearing surface against an edge of the saw guide during the cutting operation. The contact between the side edge of the saw plate and the edge of the saw guide keeps the blade of the saw along a straight path.

When a workpiece, such as a plank, a trim member or a 2×4, must be cut to a particular length, the length of the piece to be cut is measured, and then cut. When measuring a workpiece, the position of the cut line is identified and marked, such as, for example, by using a T-square and a pencil to trace the straight cut line, by laying down a chalk line to mark the cut line or by other means known in the art. The cut line, however, identifies the path of the saw blade, thus when using a guide, one must compensate for the position of the saw blade relative to the position of the bearing edge of the saw guide. In other words, one must measure from the cut line to account for the spacing between the side edge of the saw plate which abuts the saw guide and the position of the blade.

The distance between the saw blade and the side edge of the saw plate, hereafter referred to as the offset, is generally not a standard width and typically depends on not only the type of saw one is using for the cutting operation but also on the make and model of that type of saw. Thus the offset must be measured for the particular saw being used to make the desired cut. A second mark is then made on the workpiece at a distance from the cut line that corresponds to the offset for the saw being used to make the cut. In this way, when the saw is placed on the workpiece and the side edge of the saw plate positioned against an edge of the saw guide, the saw blade should align with the desired cut line.

It is evident from the above description, however, that these calculations become quite tedious and prone to errors in the cutting process, especially when numerous pieces having generally the same dimension must be cut, particularly if a variety of different saws or models are used.

As such, a need exists for a cutting guide that reduces the potential for errors and inaccuracies when determining the position of the saw guide relative to the position of the cut line.

### SUMMARY OF THE INVENTION

This invention provides a cutting guide that overcomes the above-mentioned and other problems by quickly and accurately locating the position of the saw guide relative to the cut line. The cutting guide includes a clamp, a saw guide pivotally coupled relative to the clamp and juxtaposed to a surface of the workpiece, a guiding edge on the saw guide providing a bearing support to a portion of the saw so as to guide the saw during the cutting of the workpiece, and a cutting template coupled to the clamp and juxtaposed to the surface of the workpiece. The cutting template is cuttable along a cut line so as to produce a template cutting edge. The template cutting edge identifies the position of the guiding edge relative to a cut line on the workpiece.

In one embodiment, the clamp includes a first clamping member fixedly secured to a lock bar extending from the first clamping member. A second clamping member is slidably coupled to the lock bar and is moveable so as to clamp varying sized workpieces therebetween. The second clamping member may be a quick release type with a handle having a first and second position. When the handle is in the first position the second clamping member is secured to the lock bar. When the handle is in the second position, the second clamping member is free to move along the lock bar. The saw guide is pivotally moveable between a plurality of positions. In one such position, the guiding edge of the saw guide is spaced from and generally parallel to the template cutting edge. To releasably secure the saw guide relative to the clamp, the saw guide includes a detent and the cutting template includes a plurality of recesses. The saw guide is so secured when the detent engages one of the recesses. The cutting template may be secured to the saw guide by a tongue and groove connection between the first clamping member and the template. In this way, a cutting template is quickly and easily removed or inserted into the cutting guide.

In use, a user must first cut an uncut cutting template to form the template cutting edge and its associated first template portion that is saw and angle specific. To do this, the guiding edge of the saw guide is aligned relative to the cut line on the workpiece so as to account for the saw offset. If the cut line is angled, then the saw guide must be pivotally moved to correspond to the desired cut line angle. The cutting guide is then releasably clamped to the workpiece. A portion of the saw is then abutted against the guiding edge of the saw guide and moved along the guiding edge during the cutting operation. During the cutting operation, the saw cuts through both the workpiece and the cutting template and thereby forms the template cutting edge and its associated first template portion that is saw and angle specific. A second portion of the cutting template is simply discarded.

The as-formed cutting template may then be used to cut subsequent workpieces using the same saw and at the same angle without measuring or accounting for the saw offset. To do this, the cutting edge of the template is aligned with the desired cut line on the workpiece. The cutting guide is then releasably clamped to the workpiece. A portion of the saw is then abutted against the guiding edge of the saw guide and moved along the guiding edge during the cutting operation. During the cutting operation, the saw cuts through only the workpiece along the desired cut line. A user could have a plurality of cutting templates, each template having a different first portion configuration corresponding to different saws and/or different angled cuts.

The features and objectives of this invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an exemplary cutting guide in accordance with the invention showing an uncut cutting template;

FIG. 2 is a perspective view of one embodiment of a clamp in accordance with the invention showing a rotary-type locking mechanism and clamp adaptor;

FIG. 3 is a perspective view of the cutting guide of FIG. 1 after the cutting template has been cut to form a first template portion and template cutting edge that is saw and angle specific;

FIG. 4 is a perspective view of a cutting guide showing the cutting template coupling to the clamp with a tongue-and-groove connection; and

FIG. 5 is a perspective view of the cutting template of FIG. 3 attached to a second or subsequent workpiece and showing the guiding edge of the saw guide properly positioned by aligning the template cutting edge with a desired cut line.

### DETAILED DESCRIPTION

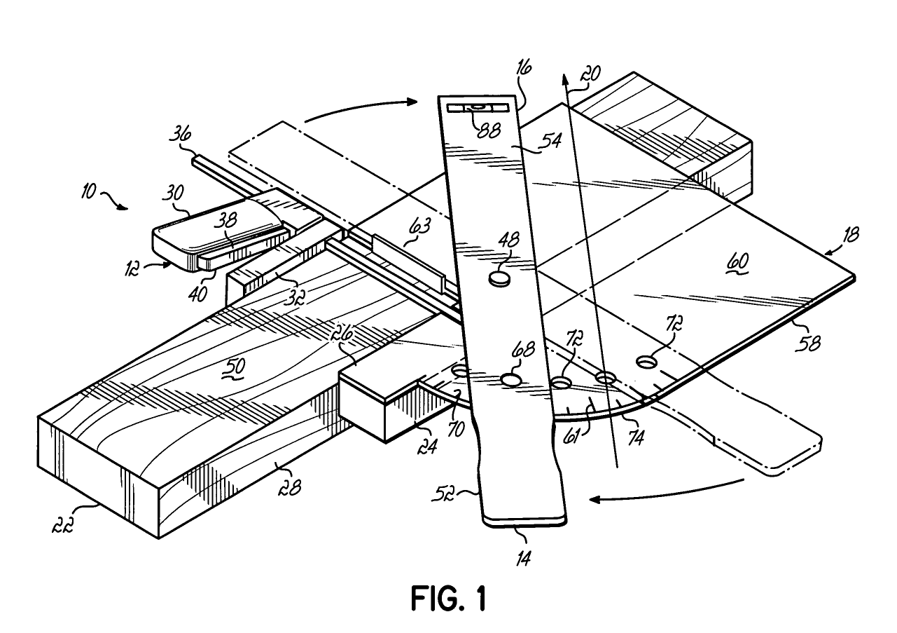

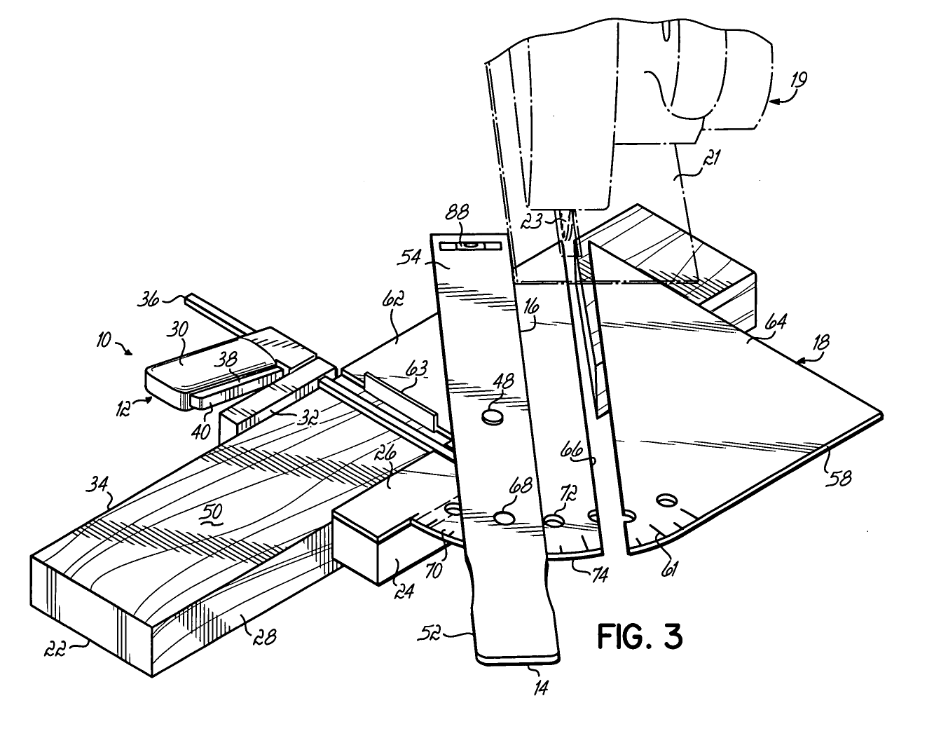

In reference to FIG. 1, an exemplary embodiment of a cutting guide 10 in accordance with the invention is shown. The cutting guide 10 inlcudes a clamp 12, a saw guide 14 pivotally coupled to clamp 12, a guiding edge 16 on saw guide 14, and a cutting template 18 also coupled to clamp 12. The cutting guide 10 is operable for guiding a saw 19 (FIG. 3) along a desired cut line 20 during a cutting operation of a workpiece 22 thereby producing a straight, accurate cut of workpiece 22.

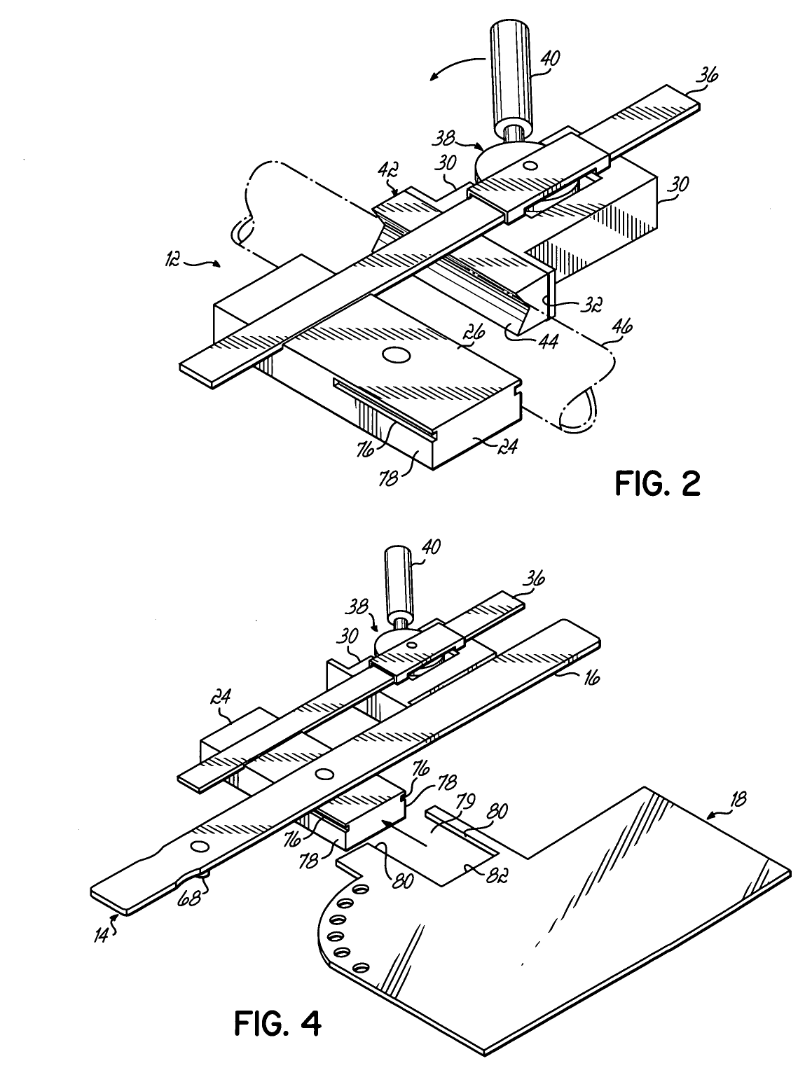

As shown in FIG. 1, the clamp 12 inlcudes a first clamping member 24 having a generally planar clamping surface 26 that abuts a corresponding surface 28 of workpiece 22 and a second clamping member 30 that likewise has a generally planar clamping surface 32 that abuts a corresponding surface 34 of workpiece 22 to thereby secure workpiece 22 between the first and second clamping members 24, 30. The clamp 12 further includes a lock bar 36 extending between first and second clamping members 24, 30. First clamping member 24 is a generally rectangular member fixedly secured to lock bar 36 that provides a base structure for cutting guide 10. Second clamping member 30, however, is moveable along lock bar 36 toward and away from the first clamping member 24 so as to accommodate varying sizes of workpieces 22. Second clamping member 30 advantageously includes a quick release locking mechanism 38 for securing the cutting guide 10 to a workpiece 22. By way of example, and as shown in FIGS. 1 and 2, the quick release locking mechanism 38 may be of the trigger type or rotary type. Those of ordinary skill in the art will further recognize other types of locking mechanisms that may be used in the invention.

In general, however, a quick release mechanism 38 includes a handle 40 moveable between a first and second position. When handle 40 is in the first position, second clamping member 30 is secured to lock bar 36. When handle 40 is in the second position, second clamping member 30 is moveable along lock bar 36 and may be positioned adjacent workpiece 22 so as to secure workpiece 22 between first and second clamping members 24, 30 when handle 40 is moved to the first position. In the trigger-type of locking mechanism 38 of FIG. 1, handle 40 is moved in a linear fashion to secure or release second clamping member 30 to lock bar 36. In the rotary-type of locking mechanism 38 of FIG. 2, handle 40 is rotated in clockwise/counter-clockwise motion to secure or release second clamping member 30 to lock bar 36.

In reference to FIG. 2, at least one of the clamping members 24, 30 may further include a clamp adaptor 42 that is removably coupled to at least one of the clamping surfaces 26, 32 by known means. Clamp adaptor 42 provides a new clamping surface 44 that is generally non-planar so as to engage a generally non-planar workpiece 46, such as for example a pipe, and thereby enhance the securement of the cutting guide 10 to the non-planar workpiece 46.

With further reference to FIG. 1, saw guide 14 is generally an elongate member pivotally coupled to clamp 12 at pivot point 48. As shown in FIG. 1, saw guide 14 couples to clamp 12 at first clamping member 24 and is juxtaposed to a top surface 50 of workpiece 22. Saw guide 14 includes a handle portion 52 for easy manipulation by a user and an outer portion 54 that overlies and extends across top surface 50. Saw guide 14 further includes a guiding edge 16 that includes a generally straight or linear portion. Guiding edge 16 is adapted to provide bearing support to a portion of the saw 19, such as the outer edge of the saw plate 21, and thereby guide the saw 19 along the desired cut line 20 during the cutting operation of the workpiece 22 (FIG. 3). By virtue of the pivotal connection at pivot point 48, saw guide 14 is pivotally moveable between a plurality of positions, each position forming a different angle between the guiding edge 16 and workpiece 22. For instance, in one position, the guiding edge 16 is perpendicular to the workpiece 22 (shown in phantom) while in another position, achieved by rotating the handle portion 52 of saw guide 14 in a clockwise direction, the guiding edge 16 is obliquely angled with respect to the workpiece 22 (shown in solid).

In further reference to FIG. 1, cutting template 18 is a generally planar rigid member that couples to clamp 12 at first clamping member 24 and is likewise juxtaposed to a top surface 50 of workpiece 22. Cutting template 18 includes an underside surface 58 that overlies and may rest on top surface 50 of workpiece 22. Saw guide 14 then overlies a top surface 60 of the cutting template 18. Cutting template 18 may further include degree indicia 61 in top surface 60 of cutting template 18 for indicating the angle of saw guide 14 relative to workpiece 22. A stop member 63 may also be provided to limit the pivotal motion of saw guide 14.

As shown in FIG. 1 and perhaps more clearly in FIG. 3, where like reference numerals refer to like features in FIG. 1, the cutting template 18 is made from a cuttable material, such as plexiglass or various plastic materials, so that when the cutting template 18 is cut along cut line 20, a first template portion 62 that remains coupled to clamp 12 and a second discard portion 64 that may simply be discarded results. The first template portion 62 includes a template cutting edge 66 that is spaced from and generally parallel to the guiding edge 16 of saw guide 14. The spacing between the guiding edge 16 and template cutting edge 66 corresponds to the offset of the saw 19 used to cut the cutting template 18. In this way, the cutting template 18 then becomes specific to the particular saw 19 used to cut the cutting template 18 and the particular angle saw guide 14 made with workpiece 22 when cutting template 18 was cut. As further explained below, a cutting template 18 that has been cut using a particular saw and at a particular angle may advantageously be used on any subsequent workpieces where it is desired to have the same cut configuration (i.e., angle of the cut) using the same saw.

So that the saw guide 14 does not move during a cutting operation, thereby affecting the accuracy of the cut, the position of the saw guide 14 relative to the cutting edge 10 is releasably fixed. As shown in FIG. 1, one way to do this is to have the saw guide 14 cooperate with cutting template 18 to fix its position. Saw guide 14 includes a detent 68 extending from a bottom surface of the saw guide 14 and toward cutting template 18. Moreover, cutting template 18 includes an arcuate portion 70 having a plurality of recesses 72 spaced along an arcuate path directly below detent 68 so that detent 68 may engage any one of the plurality of recesses 72. When detent 68 engages one of the recesses 72, saw guide 14 becomes releasably secured to cutting template 18 to await any accidental or unintentional movement of saw guide 14. It should be understood that those having skill in the art will recognize additional or alternate configurations for fixing the saw guide 14. For example, the arcuate edge 74 of arcuate portion 70 may include a plurality of v-shaped recesses or notches and the underside of saw guide 14 may include a corresponding v-shaped spring loaded detent or stop member so that when the stop member engages one of the notches, saw guide 14 is fixed relative to the cutting template 18.

The cutting template 18 may be coupled to the cutting guide 10 in a number of ways known in the art. For instance, one way is to adhesively connect the cutting template 18 to first clamping member 24, as shown in FIG. 1. In many cases, however, it is desirable and advantageous to be able to insert and remove a cutting template 18 from cutting guide 10 in a quick and easy fashion. As shown in FIG. 4, one way to connect cutting template 18 to cutting guide 10 is with a tongue and groove connection. First clamping member 24 includes a pair of grooves 76 in side surfaces 78. Moreover, cutting template 18 includes a notch 79 having opposed side walls 80 and base wall 82. To couple cutting template 18 to first clamping member 24, side walls 80 engage openings in grooves 76 and slide along grooves 76 until base wall 82 contacts first clamping member 24. This tongue and groove connection frictionally secures cutting template 18 to cutting guide 10 but permits the quick removal and installation of the cutting template 18.

FIGS. 1, 3 and 5 illustrate how the cutting guide 10 of this invention may be used. As shown in FIG. 1, the cutting template 18 must be cut to form a template cutting edge 66 and its associated first template portion 62 that is saw and angle specific. This is usually done during a cutting operation of the workpiece 22 so as to not waste a cutting operation. Thus when using the cutting template 18 the first time, the position of the guiding edge 16 relative to the desired cut line 20 must be marked. This is usually done by knowing the position of the cut line 20 on the workpiece 22, compensating for the offset in the saw being used to make the cut and marking the position of the guiding edge on workpiece 22. The cutting guide 10 is then releasably clamped on to workpiece 22 so that guiding edge 16 aligns with the guiding edge mark on workpiece 22. The saw blade 23 of the saw 19 should then align with the desired cut line 20. A portion of the saw, such as the edge of the saw plate 21, is then abutted against the guiding edge 16 of saw guide 14 and moved along guiding edge 16 during the cutting operation. For this first time use, the saw 19 cuts through both workpiece 22 and cutting template 18.

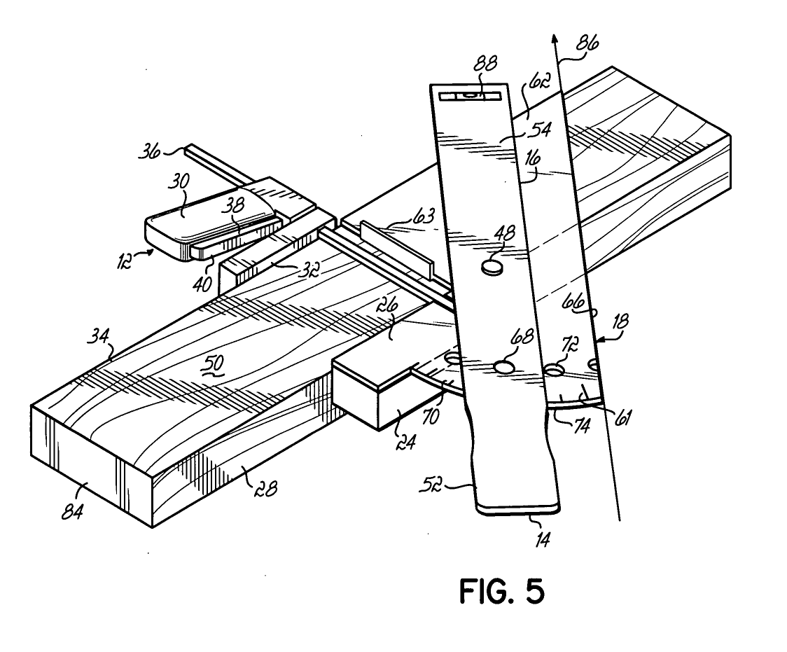

As shown in FIG. 3, this cutting operation produces a cutting template 18 having first template portion 62, second discard portion 64 and template cutting edge 66. The cutting template 18 having first template portion 62 and template cutting edge 66 is then saw and angle specific. Now as shown in FIG. 5, cutting template 18 having first template portion 62 that is saw and angle specific may be advantageously used on subsequent workpieces 84 where it is desired to cut workpiece 84 using the same saw and for the same cut configuration. To do this, the workpiece 84 is measured and the desired cut line 86 is marked on workpiece 84. The cutting guide 10 is positioned on the workpiece 84 so that the template cutting edge 66 aligns with the desired cut line 86. The cutting guide is then releasably clamped to workpiece 86. A portion of the saw 19 is then abutted against the guiding edge 16 of the saw guide 14 and moved along guiding edge 16 during the cutting operation. During the cutting operation, only the workpiece 84 is cut since the cutting template has already been formed. Note that the user does not have to compensate for the offset of the saw 19 in that the guiding edge 16 of the saw guide 14 is properly positioned by simply aligning the template cutting edge 66 with the desired cut line 86. This feature is increasingly advantageous when numerous workpieces having the same cut configuration must be made using the same saw. It is contemplated that a user would have a plurality of cutting templates 18, each template having a different first portion configuration 62 corresponding to different saws and/or different angled cuts.

The invention as described herein has a number of advantages. The primary advantage is that, after the cutting template 18 is cut to produce the template cutting edge 66 on first template portion 62, a user no longer has to know or mark the position of the guiding edge 16 of the saw guide 14, but must only know the position of the cut line 20, which is the normal course of cutting operations. Removing this step greatly reduces the errors and mistakes made when compensating for the offset in the saw being used to make the cut. This also reduces the time to make the cuts on a workpiece, especially when there are numerous workpieces having the same type of cut configuration. Another advantage of the present invention is that because the cutting guide 10 is clamped onto the workpiece, the user may use two hands when operating the saw 19. This then allows a user to make a safer cut without sacrificing cutting accuracy. The safety of cutting operations is also improved by providing a rigid platform from which to start the cutting operation. In many instances, carpenters and other users do not have a platform or starting surface for which to operate the saw, such as a circular saw, before engaging the workpiece. In this invention, the cutting template 18 is sized to provide a platform for operating the saw prior to engaging the workpiece. This makes the entry into the workpiece cleaner and reduces the likelihood of the workpiece “kicking” or presenting other safety hazards.

The cutting guide 10 may also include other features frequently used in woodworking and construction applications. For instance, the saw guide may include a level indicator 88 for gaging the orientation of the saw guide. Moreover, the saw guide and first clamping member may be configured to be in perpendicular relation to each other. When so configured, the cutting guide may also be used as a T-square. The saw guide and/or first clamping member may then include ruler markings or indicia of length typically found on a carpenter's square.

While this invention has been illustrated by the description of the various embodiments thereof, and while the embodiments have been described in considerable detail, it is not intended to restrict or in any way limit the scope of the appended claims to such detail. For instance, those of ordinary skill in the art will recognize that the cutting template does not have to be removable from the cutting guide but a user may have a different cutting guide for the user's various saws and cut configurations. If this be the case then it should be recognized that the saw guide does not have to move relative to the cutting template and may in fact be integrally formed with the cutting template. Alternately, the integrally formed saw guide and cutting template may be the quick attachment type and a user have a plurality of these saw guide/cutting template inserts having different combinations for the user's various saws. Furthermore, it should be understood that while the illustrated embodiments show a cutting guide directed towards cutting operations from left to right when the saw guide is angled, the cutting guide may also be configured to make cuts from right to left when the saw guide is angled.

Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

1. A cutting guide for guiding a saw along a cut line during a cutting operation of a workpiece, the cutting guide comprising:
a clamp;
a saw guide pivotally coupled relative to said clamp and adapted to be juxtaposed to a surface of the workpiece;
a guiding edge on the saw guide adapted to provide bearing support to a portion of the saw and thereby guide the saw along the cut line during the cutting operation of the workpiece; and
a cutting template coupled to said clamp and adapted to be juxtaposed to the surface of the workpiece, said cutting template being cuttable by the saw along the cut line to produce a template cutting edge on a first template portion of the cutting template and a second discard portion of the cutting template.

2. The cutting guide of claim 1 wherein said clamp comprises a first and second clamping member, said clamping members adapted to secure the workpiece therebetween.

3. The cutting guide of claim 2 wherein said clamp further comprises a lock bar, said first clamping member being fixedly secured to said lock bar, said second clamping member being slidably coupled to said lock bar.

4. The cutting guide of claim 3 wherein said second clamping member includes a handle moveable between a first and second position, said second clamping member being secured to said lock bar when said handle is in the first position, said second clamping member being moveable along said lock bar when said handle is in the second position.

5. The cutting guide of claim 1 wherein at least one of said first and second clamping members includes a clamp adaptor coupled thereto and configured to securely engage a non-planar workpiece.

6. The cutting guide of claim 1 wherein said saw guide is pivotally moveable between a plurality of positions, said guiding edge of said saw guide being spaced from and generally parallel to the template cutting edge when the saw guide is in one of said positions.

7. The cutting guide of claim 1 wherein said saw guide is pivotally mounted to said clamp.

8. The cutting guide of claim 1 wherein said saw guide includes a detent, said cutting template includes a plurality of recesses, the position of said saw guide relative to said clamp being releasably secured when said detent engages one of said recesses.

9. The cutting guide of claim 1 wherein said cutting template further comprises degree indicia adapted to indicate an angle of the saw guide relative to the workpiece.

10. The cutting guide of claim 1 wherein said first clamping member is coupled to said cutting template by a tongue and groove connection.

11. The cutting guide of claim 1 wherein said cutting template is selectively and releasably coupled to said clamp, the cutting guide further comprising a plurality of cutting templates each of which has a different template cutting edge and associated first template portion configuration.

12. A cutting guide for guiding a saw along a cut line during a cutting operation of a workpiece, the cutting guide comprising:
a clamp;
a saw guide coupled relative to said clamp and adapted to be juxtaposed to a surface of the workpiece;
a guiding edge on the saw guide adapted to provide bearing support to a portion of the saw and thereby guide the saw along the cut line during the cutting operation of the workpiece; and
a cutting template coupled to said clamp and adapted to be juxtaposed to the surface of the workpiece, said cutting template having a template cutting edge spaced apart and generally parallel to the guiding edge.

13. The cutting guide of claim 13 wherein said clamp comprises a first and second clamping member, said clamping members adapted to secure the workpiece therebetween.

14. The cutting guide of claim 14 wherein said clamp further comprises a lock bar, said first clamping member being fixedly secured to said lock bar, said second clamping member being slidably coupled to said lock bar.

15. The cutting guide of claim 15 wherein said second clamping member includes a handle moveable between a first and second position, said second clamping member being secured to said lock bar when said handle is in the first position, said second clamping member being moveable along said lock bar when said handle is in the second position.

16. The cutting guide of claim 13 wherein said saw guide is pivotally moveable between a plurality of positions, said guiding edge of said saw guide being spaced from and generally parallel to the template cutting edge when the saw guide is in one of said positions.

17. The cutting guide of claim 13 wherein said saw guide includes a detent, said cutting template includes a plurality of recesses, the position of said saw guide relative to said clamp being releasably secured when said detent engages one of said recesses.

18. The cutting guide of claim 13 wherein said cutting template further comprises degree indicia adapted to indicate an angle of the saw guide relative to the workpiece.

19. The cutting guide of claim 13 wherein said first clamping member is coupled to said cutting template by a tongue and groove connection.

20. The cutting guide of claim 13 wherein said cutting template is selectively and releasably coupled to said clamp, the cutting guide further comprising a plurality of cutting templates each of which has a different template cutting edge and associated first template portion configuration.

21. A cutting guide for guiding a saw along a cut line during a cutting operation of a workpiece, the cutting guide comprising:
a clamp including a first and second clamping member adapted to secure the workpiece therebetween, said lamp further including a lock bar, said first clamping member being fixedly secured to said lock bar, said second clamping member being slidably coupled to said lock bar, said second clamping member further including a handle moveable between a first and second position, said second clamping member being secured to said lock bar when said handle is in the first position, said second clamping member being moveable along said lock bar when said handle is in the second position;
a saw guide coupled relative to said clamp and adapted to be juxtaposed to a surface of the workpiece, said saw guide being pivotally moveable between a plurality of positions and having a detent extending from said saw guide;
a guiding edge on the saw guide adapted to provide bearing support to a portion of the saw and thereby guide the saw along the cut line during the cutting operation of the workpiece; and
a cutting template coupled to said clamp and adapted to be juxtaposed to the surface of the workpiece, said cutting template having a template cutting edge spaced apart and generally parallel to the guiding edge, said cutting template having a plurality of recesses, the position of said saw guide relative to said clamp being releasably secured when said detent engages one of said recesses, said cutting template further including degree indicia adapted to indicate an angle of said saw guide relative to the workpiece.

22. A cutting template adapted to be used in combination with a cutting guide for guiding a saw along a cut line during a cutting operation of a workpiece, the cutting guide comprising a clamp adapted to secure the cutting guide to the workpiece and a saw guide pivotally coupled to the clamp, the cutting template comprising:
a generally planar member adapted to couple to the clamp and to be juxtaposed to a surface of the workpiece, said cutting template being cuttable by the saw along the cut line to produce a template cutting edge on a first template portion of the cutting template and a second discard portion of the cutting template.

23. The cutting template of claim 23 further comprising a plurality of recesses, said recesses adapted to cooperate with the saw guide to secure the position of the saw guide relative to the clamp.

24. The cutting template of claim 23 further comprising degree indicia adapted to indicate an angle of the saw guide relative to the workpiece.

25. (canceled)

26. (canceled)

27. (canceled)

28. (canceled)

29. (canceled)

30. (canceled)
